(19) United States
(12) Patent Application Publication
(10) Pub. No.: US 2002/0026336 A1
(43) Pub. Date: Feb. 28, 2002

(54) Method and system for creating one or more customized travel web pages over a computer network

(76) Inventors: Michael Eizenburg, Wellesley, MA (US); Angela Beauchamp, Rio Rancho, NM (US)

Correspondence Address: Robert V. Klauzinski, Esq., MINTZ, LEVIN, COHN, FERRIS GLOVSKY and POPEO, P.C., One Financial Center, Boston, MA, 02111, US

(21) Appl. No.: 09/771,196

(22) Filed: Jan. 26, 2001

Related U.S. Application Data
(60) Provisional application No. 60/178,684, filed on Jan. 28, 2000.

(51) Int. Cl. G06F 17/60

(52) U.S. Cl. 705/5

(57) ABSTRACT

A server running Journey Maker software is provided for generating at least one customized travel Web page, which is accessible by a traveler or end user of at least one client computer over a computer network. The customized travel Web page is further accessible to travel group leaders, travel agents and travel services suppliers, via the computer network. The customized travel Web page is created through an interactive process that allows the traveler and the travel agent to jointly decide upon the details of the journey. Additionally, the customized travel Web page may be modified and updated as the traveler requires. The interactive process creates the customized travel Web page by populating a number of travel templates with travel information related to the travel information requirements provided by the traveler to the travel agent.

### RELATED APPLICATIONS

This application claims priority to U.S. Provisional Patent Application Ser. No. 60/178,684 filed Jan. 28, 2000.

### FIELD OF THE INVENTION

The present invention relates to an computer network based method and system for providing a user or client with a customized Web page travel program. More particularly, it relates to a method and system for providing a user with a customized Web page having travel program information based on user predefined travel requirements.

### BACKGROUND

As networks of linked computers become an increasingly more prevalent concept in everyday life, so-called “on-line” or “electronic” interactions between computer users have begun to spread into many different areas of our lives. One of these areas is the marketplace for goods and services the past couple of years there has been an explosive growth in the use of the globally-linked network of computers known as the Internet, and in particular of the World Wide Web (“WWW”), which is one of the facilities provided by the Internet. The WWW comprises many pages or files of information, distributed across many different server computer systems. Some examples of information that can be stored on such pages includes: details of a company's organization, contact data, product data and company news. This information can be presented to the user's computer system (“client computer system”) using a combination of text, graphics, audio data and video data. Each page is identified by a Universal Resource Locator (“URL”). The URL denotes both the server machine and the particular file or page on that machine. There can be many pages or URLs resident on a single server.

In order to use the WWW, a client computer system runs a piece of software known as a graphical Web browser, such as Internet Explorer (provided as part of the Windows operating system from Microsoft Corporation), or the Navigator program available from Netscape Communications Corporation. The client computer system interacts with the browser to select a particular URL, which in turn sends a request for that URL or page to the server identified in the URL. Typically the server responds to the request by retrieving the requested page, and transmitting the data for that page back to the requesting client computer system. The client/server interaction is performed in accordance with the hypertext transport protocol (“HTTP”). This page is then displayed to the user on the client screen. The client can also cause the server to launch an application, for example, to search for WWW pages relating to particular topics.

Most Web pages contain one or more references to other Web pages which need not be on the same server as the original page. Such references can generally be activated by the user selecting particular locations on the screen, typically by clicking a mouse control button. These references or locations are known as hyper-links and are typically identified by the browser in a particular manner (for example, any text associated with a hyper-link can be underlined or in a different color). If a user selects the hyper-link, then the referenced page is retrieved and replaces the currently displayed page.

One problem associated with purchasing goods and/or services via the Internet is that the operator of the client computer must search for and connect to a vendor's Web page in order to notify the vendor of an intent to purchase. In some instances, the operator can have a list of many different items to purchase, such as an equipment list, which items can be available from a number of different vendors. In this instance, the operator of the client computer must search for and connect to the Web pages of a number of different vendors in order to purchase all of the items contained on the operator's list. This process of searching for and connecting to Web pages can require substantial time and effort on the part of the operator because it is not always obvious where on the Internet to locate specific items. As a result, operators of client computers often find themselves endlessly searching the Internet for specific items at a desirable price.

Therefore, an unsolved need exists for a method and system for performing computer-based on-line or electronic commerce that reduces or eliminates the time required for an operator to search for and connect to the Web page of a vendor of each particular good and/or service.

### SUMMARY OF THE INVENTION

An object of the present invention is to set forth a computer network based method and system for providing a user with a plurality of customized travel Web pages that enables the user to select from items and/or services contained in the Web page for obtaining information related to the item and/or service, as well as to consummate travel reservations.

In accordance with embodiments of the present invention, the system for providing a user with a computer network based customized travel program Web page comprises at least one client computer coupled to a server via the computer network. One or more vendor computers are also coupled to the server via the computer network. The system enables bi-directional communication between the server, client computer and vendor computers.

In one embodiment, the system for providing at least one client computer with a plurality of customized travel Web pages over a computer network includes a server coupled to the computer network. The server is constructed and arranged to receive travel information requirements from the at least one client computer over the computer network and to process the travel information requirements to generate the plurality of customized travel Web pages. The system further includes a database coupled to the server for storing travel archival information, templates and the plurality of customized travel Web pages. The server is further constructed and arranged to query the travel archival information stored in the database for locating travel match information and for populating the templates with the travel match information to generate the customized traveler Web pages. The system further includes one or more vendor computers coupled to the server over the computer network. The vendor computers are adapted to receive the travel information requirements from the server and to locate travel match information. The travel match information is communicated to the server for enabling the server to populate the templates with the travel match information to generate the customized traveler Web pages.

In another embodiment, the method for providing at least one client computer with a plurality of customized travel Web pages over a computer network comprises the steps of receiving travel information requirements at the server from the at least one client computer; generating a Web pages having information related to the travel information requirements provided by the at least one client computer, the Web page including linking URLs for enabling the at least one client computer to communicate with one or more vendor computers; and enabling the at least one client computer to access the Web page. The user of the at least one client computer can view the Web page, which has been generated in real-time, according to the user provided travel information requirements. The user can thereafter communicate with the server and/or vendor computers to consummate travel information reservations.

In another embodiment, the method for providing at least one client computer with a plurality of customized travel Web pages over a computer network comprises the steps of receiving travel information requirements at a server computer from the at least one client computer; generating a plurality of customized travel Web pages having information related to the travel information requirements; and presenting the plurality of customized travel Web pages to the at least one client computer for enabling a user of the at least one client computer to obtain travel related information, services or to consummate travel reservations.

The step of generating the plurality of customized travel Web pages further includes the steps of comparing the travel information to archived travel information stored in a database to locate travel match information; and populating a plurality of Web page templates with the travel match information to generate the plurality of customized travel Web pages.

The step of generating the plurality of customized travel Web pages further includes the steps of communicating the travel information requirements to at least one vendor computer; and receiving vendor information from the at least one vendor computer, the vendor information being related to the travel information requirements.

The method further includes the step of populating the plurality of Web page templates with the vendor information to generate the plurality of customized travel Web pages. The method further includes the step of storing the plurality of customized travel Web pages in a database.

After the step of presenting the plurality of customized travel Web pages to the at least one client computer, the method further includes the step of communicating information from the at least one client computer to the at least one vendor computer to consummate travel reservations. Alternatively, after the step of presenting the plurality of customized travel Web pages to the at least one client computer, the method further includes the step of communicating information from the at least one client computer to the server computer to consummate travel reservations.

After the step of presenting the plurality of customized travel Web pages to the at least one client computer, the method further includes the step of debiting an account of an end user of the at least one client computer a predetermined fee. Alternatively, after the step of presenting the plurality of customized travel Web pages to the at least one client computer, the method further includes the step of charging an end user of the at least one client computer a predetermined fee.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 is a high level block diagram of the internet-based system for providing a customized travel program Web page in accordance with principles of the present invention; and

FIGS. 2-54 show various Web pages for executing one specific embodiment of the present invention on the system shown in FIG. 1.

### DETAILED DESCRIPTION

In accordance with embodiments of the present invention, a method and system for providing one or more users with a computer network based customized travel program Web page is set forth which enables a user to obtain relevant travel information and make travel reservations.

In order to facilitate a further understanding of the invention, a system 10 for conducting computer-based or electronic commerce (“e-commerce”) using a computer network 15, such as the Internet, embodying the method and system 10 of the present invention is described herein.

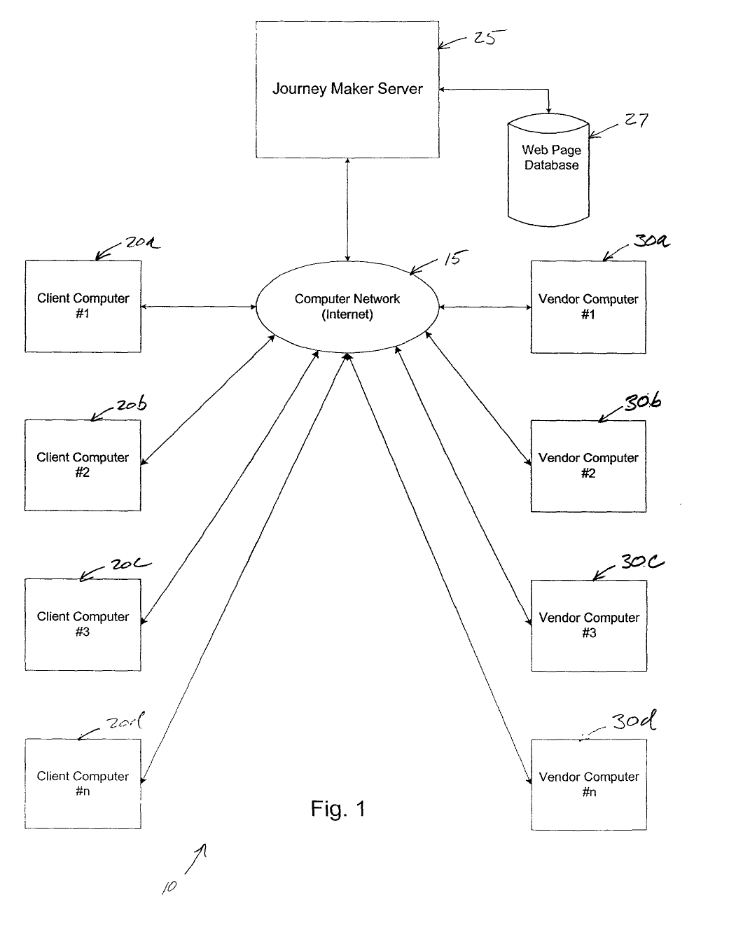

As shown in FIG. 1, an embodiment of the system 10 of the present invention includes at least one client computer 20a, 20b, 20c and/or 20d (hereinafter collectively referred to as “client computer(s) 20”) coupled to a Journey Maker server 25 via the computer network 15. The server 25 can comprise one or more conventional computer servers such as one or more “NT-servers”, “MasOS”, or “Unix Solaris servers.” These computer servers can be programmed with conventional server software such as: “Windows Explorer”, “Netscape Enterprise”, “Navigator”, or “Earthlink.” Furthermore, these computer servers can be programmed with conventional Web page interface software such as: “Visual Basic”, “Java”, “JavaScript”, “XML”, “HTML/DHTML”, “C++”, “J+38 , “Perlscript”, or “ASP.” The servers can be further programmed with conventional search engines such as: “Yahoo”, “Lycos”, or “Alta Vista.”

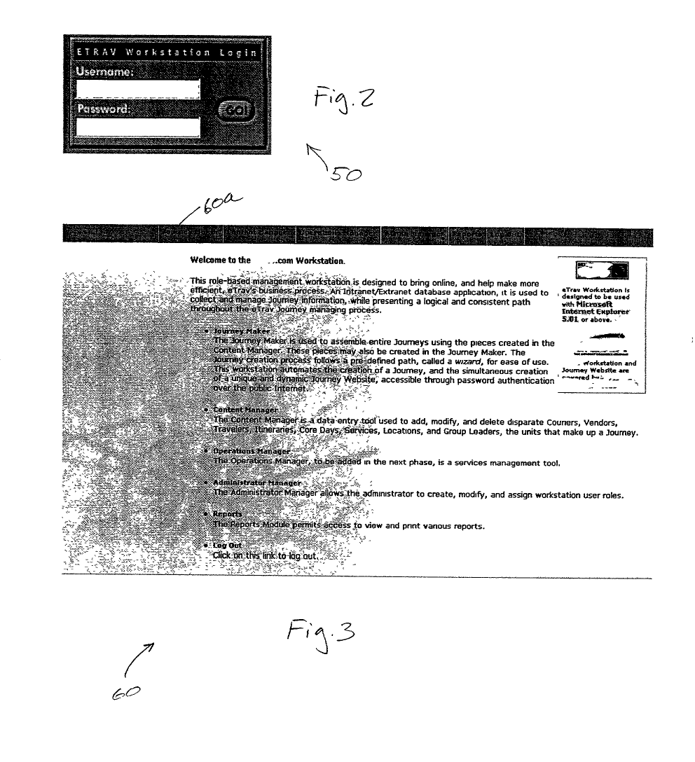

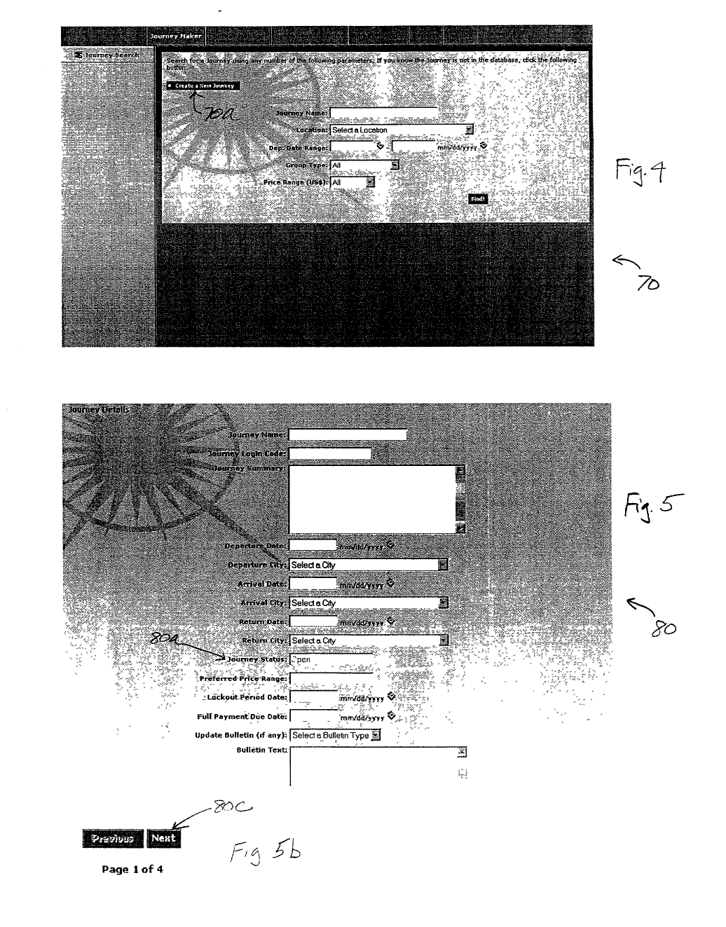

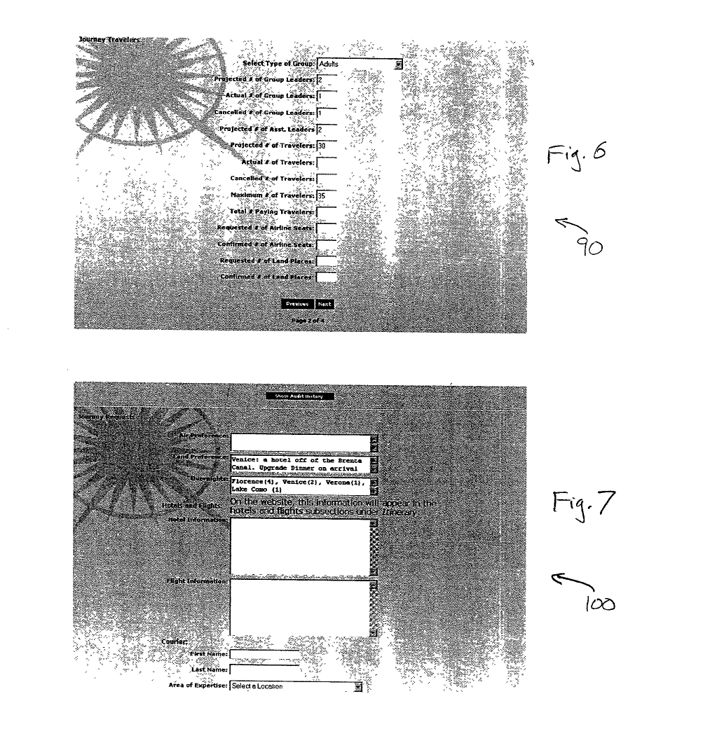

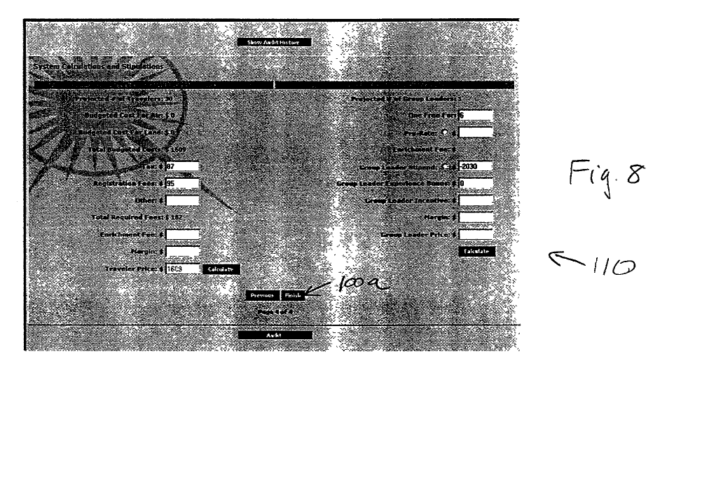

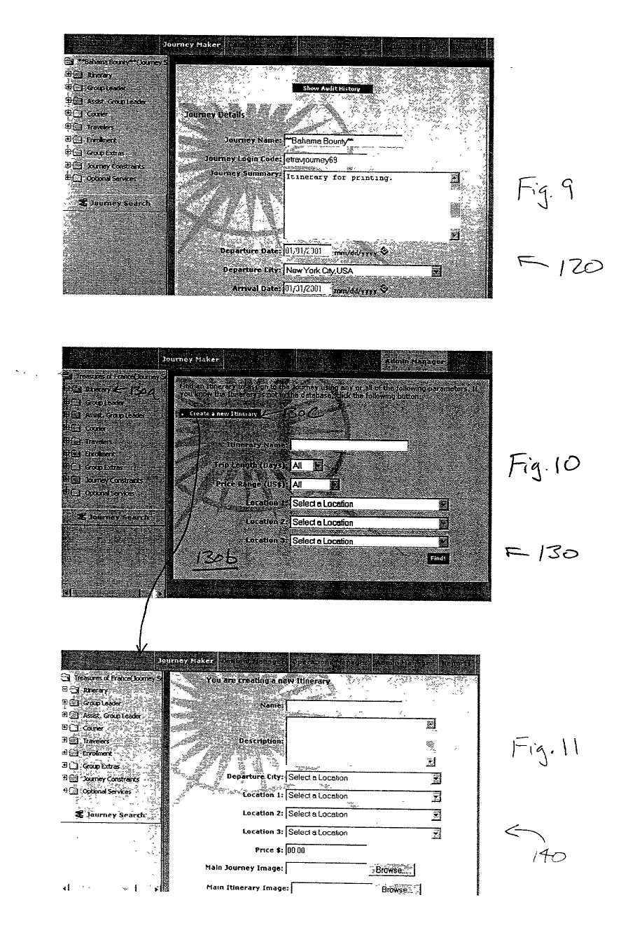

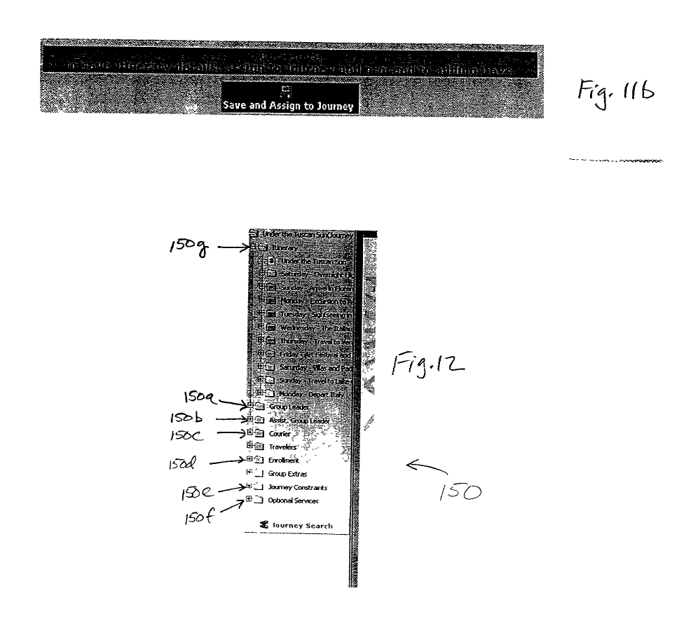

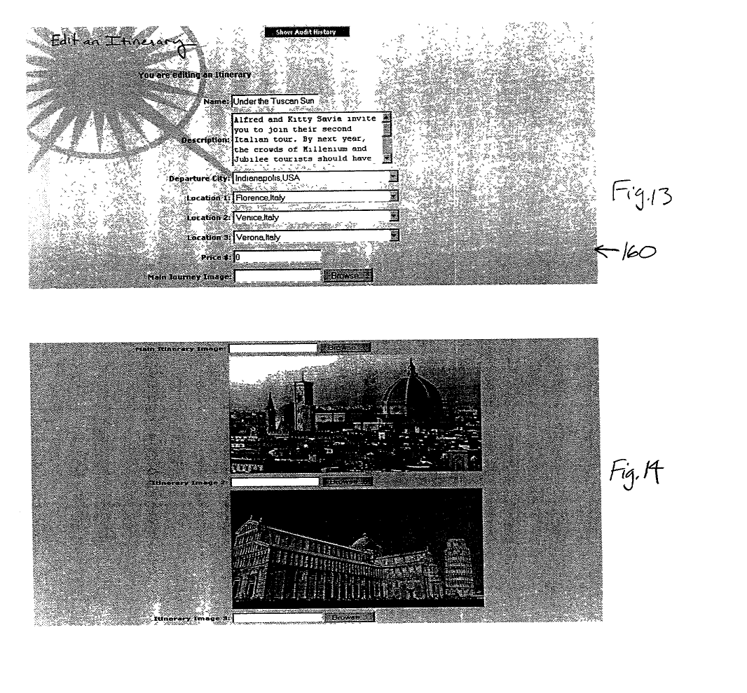

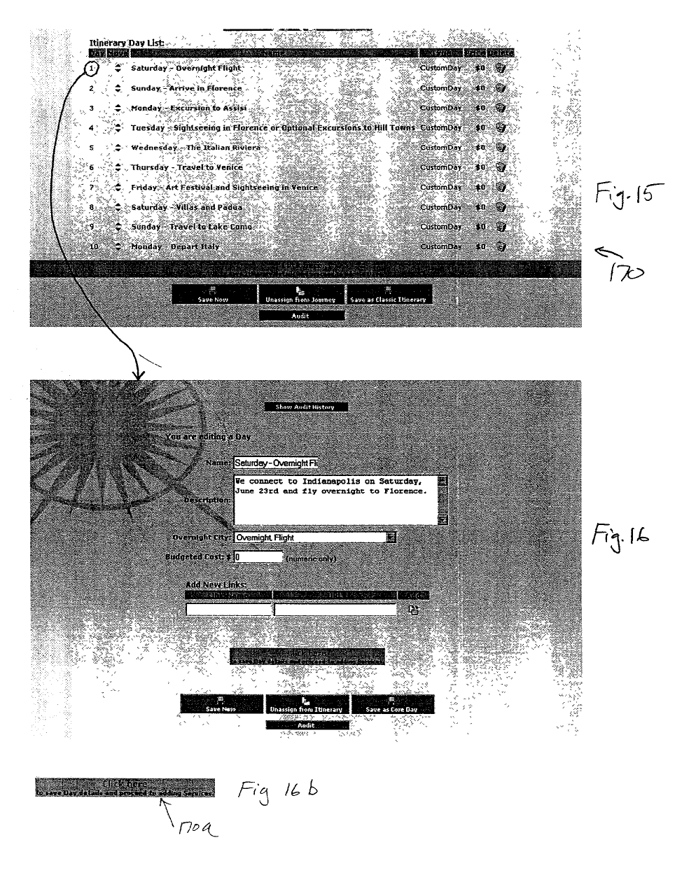

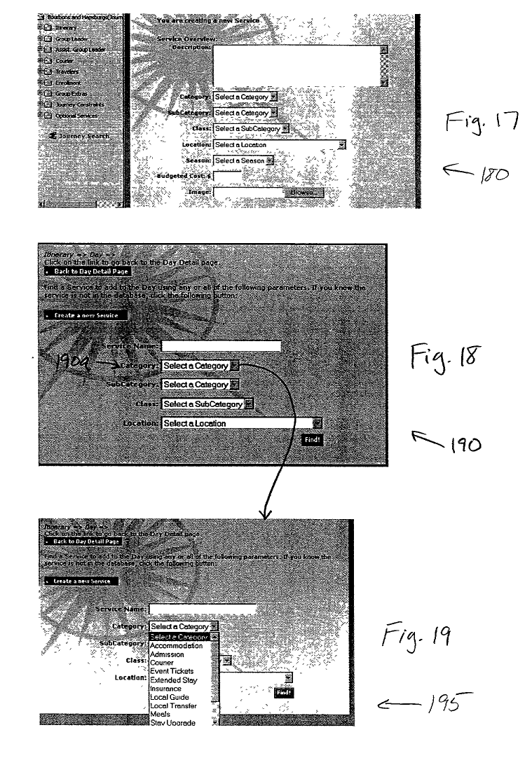

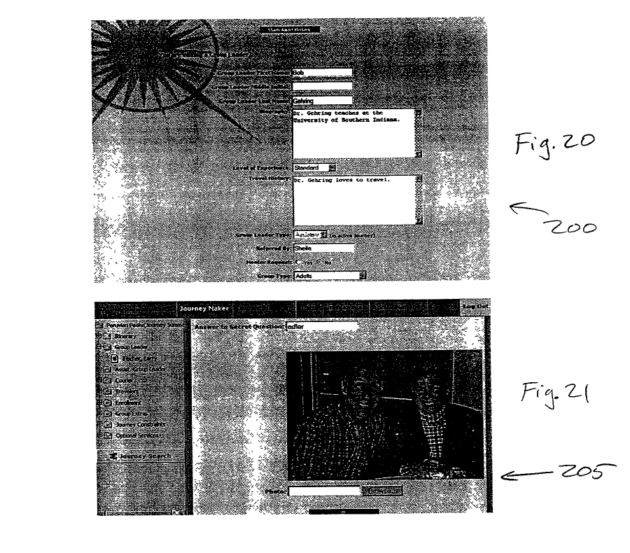

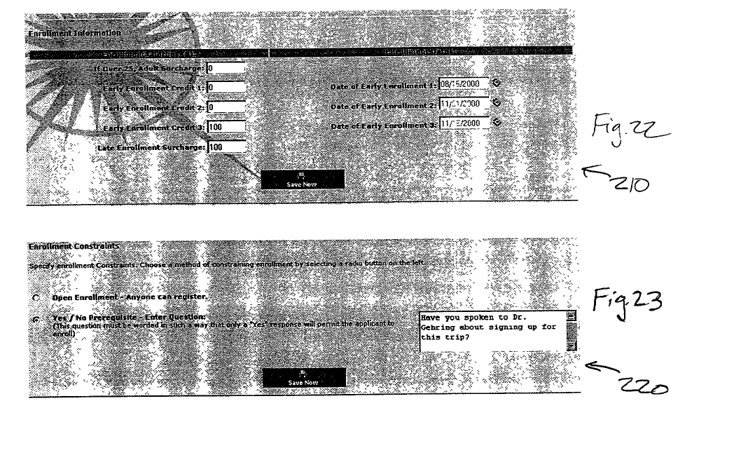

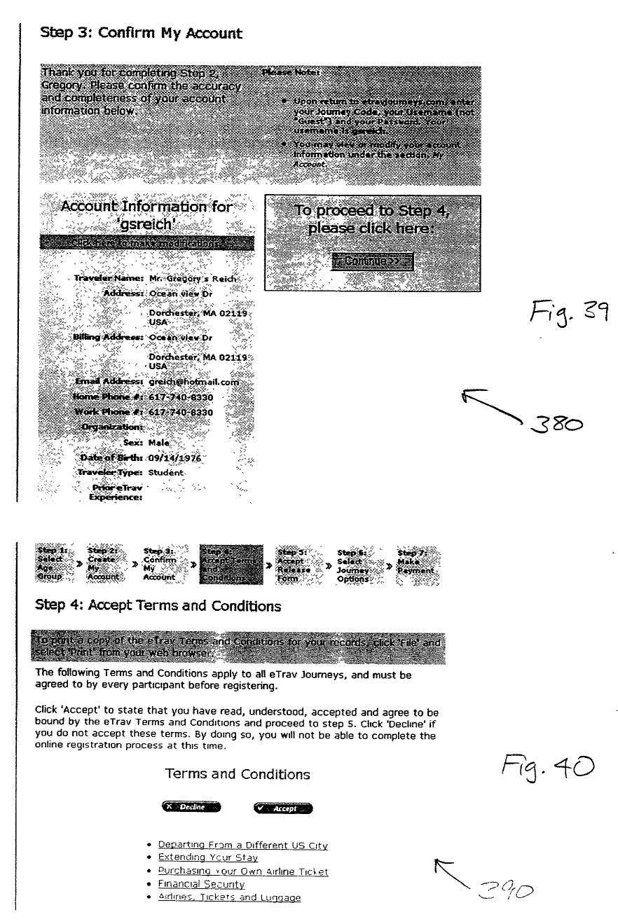

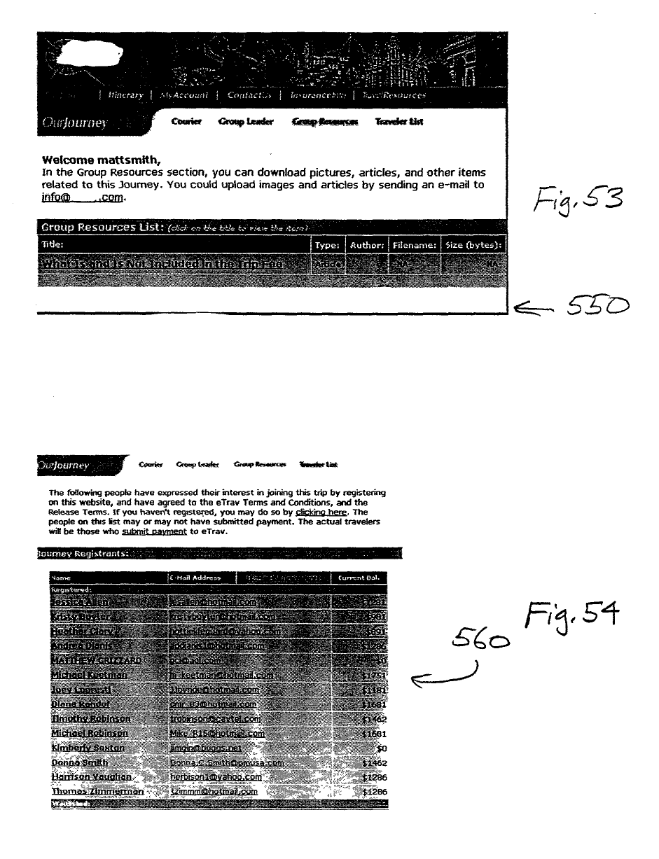

One or more vendor computers 30a, 30b, 30c and 30d (hereinafter collectively referred to as “vendor computer(s) 30”) is also coupled to the server via the computer network 15. The vendor computers 30 each contain Web pages (not shown) offering goods and/or services for purchase by an end user or traveler. Each of the client computers 20 runs conventional Web browser software for enabling the client computers 20 to search for and connect to travel related Web pages, as shown in FIGS. 2-54, which will be discussed in detail below. The client computer or computers 20 can access these travel related Web pages, which are provided by the server 25. The client computer 20 can also access other Web pages provided by the one or more vendor computers 30 to search for and obtain travel related information, goods and/or services. Further, the client computers 20 can connect to other computers/servers (not shown) that are also coupled to the Internet for accessing yet other Web pages.

The server 25 is coupled to the computer network 15, via conventional hardware and software, which interface software enables bi-directional data communications between the server 25, client computers 20, vendor computers 30 and the plurality of other computers/servers coupled to the computer network 15.

In one embodiment, the server is a series of mainframe, midrange PCs, and workstation computers, RISC servers, or Intel based servers coupled to the computer network 15, via a network of Web/http servers, video servers, secure Web servers, remote access servers and firewall proxy servers, as well as server software such as Netware, Windows NT, LAN server, Ethertalk, and/or Pathworks.

In one embodiment, the one or more vendor computers 30 are defined as services vendors. Each service vendor includes one or more Web pages directed to sales and information related to a particular service. More specifically, each vendor's Web page includes a number of active buttons or icons that permit an end user or traveler connected thereto to select particular services associated with each active button. In order to select a particular service, the end user or traveler can click on an active button with a mouse pointer, which active button is associated with a desired services to be purchased or reserved. After clicking on an active button with the mouse pointer, the end user or traveler is prompted for payment information in anticipation of completing the transaction, which can result in reservations being made for the desired service such as hotel accommodations.

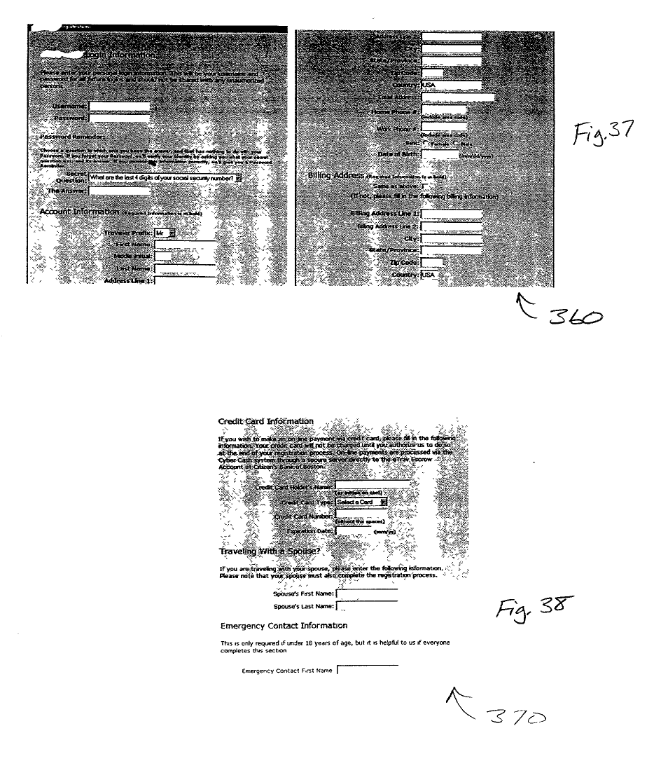

The Journey Maker 25 server is further coupled to a database 27. The database 27 is adapted for storing a plurality of archival travel information, and a plurality of travel Web page templates (which will be described in detail below with reference to FIGS. 2-33) and a plurality of customized travel Web pages (which will be described in detail below with reference to FIGS. 35-54).

The archival travel information stored in the database can include previously obtained travel information, such as regularly scheduled airline flights, hotel accommodation and/or excursions or tours. The travel Web page templates can include a number of predetermined blank data fields, which can be populated jointly or individually by either the end user, travel agent or user of the system 10. The plurality of customized travel Web pages can include goods and/or services arranged in the predetermined fields of the templates. The customized travel Web pages can be configured in real-time by the end user of the client computer 20 to accommodate the user's desires for particular goods and/or services.

In an embodiment, the client computer 20 can provide the server 25 with specific travel information including a particular destination, air travel vendor, activities or excursions. At the same time, the server 25 can generate a client customized travel program Web page including information related to the particular destination, air travel vendor, activities or excursions. Additionally, the client customized Web page can include nested links to vendor Web pages defined on vendor computers 30, so that the end user of the client computer 20 can directly access the vendor computer 30 to consummate a transaction for the procurement of a desired service.

By way of one specific example, upon receiving travel requirements information from a client computer 20 for a vacation from May 4th, 2000 to May 12^{th} 2000, with Holland as a destination and with general sightseeing as a desired excursion, the server 25 can generate a customized Web page (not shown). The customized Web page can include a ten day itinerary, whereby each day includes a proposed sightseeing excursion. The end user of the client computer 20 can also view information, as well as select information from alternative excursions, by selecting a nested link associated with each day defined on the itinerary. The Web page can further include a number of photographs which are associated with sight seeing excursions defined on the itinerary. Additionally, the Web page can include hotel information as well as pricing information. Each hotel listing provided in the Web page also includes a nested link, which can be selected to enable the user to view additional information related to the hotel, as well as to enable the user of the client computer 20 to communicate with a vendor computer 30 associated with the hotel. Thus, the client computer 20 can communicate with the vendor computer 30 associated with the hotel to consummate reservations for accommodations therewith. Similarly, the customized Web page can include airline flight information. A nested link is provided with each airline listing provided in the Web page to enable the user of the client computer 20 to communicate with a vendor computer 30 associated with the airline so that the user can consummate flight reservations. Other general travel information can be provided in the customized Web page such as traveler's insurance information, passport information as well as suggested packing tips.

In another embodiment, in group travel arrangements, a plurality of users operating one or more client computers 20 can provide a number of travel requirements to the server 25 for a particular destination. Thereafter, the server 25 can generate a single client customized Web page (not shown) in a similar manner as that previously described. In this instance, the one or more client computers 20 can access the single client customized Web page, with read-only privileges, and view each days itinerary choices, airline information, hotel information, as well as other general information. A predetermined client computer 20, which is in communication with the Web page, can be designated with travel consummation privileges for consummating travel plans as an agent of the one or more client computers 20. In this manner, the server 25 can be used to plan and consummate group travel plans, where all members of a group have access to travel information contained in the Web page.

In accordance with the present invention, a method for providing one or more end users with a computer network based customized travel Web page comprises the steps of: receiving travel information requirements at a server 25 from a client computer 20; generating a Web page having information related to the travel information requirements, the Web page including linking URLs for enabling the client computer 20 to communicate with a vendor computer 30; and providing the Web page to the client computer 20. At this point, the user of the client computer 20 can view the Web page, which has been generated in real-time in accordance with user provided travel information requirements. Thereafter, the user can communicate with the server 25 and/or vendor computers 30 to consummate travel information reservations prior to travel.

In one specific embodiment, Journey Maker software, which is executable on the server 25, can generate a number of customized travel programs/itineraries viewable as personalized or customized Web pages as shown in FIGS, 2a-55, in accordance with aspects of the present invention. These customized Web pages are accessible to travelers, group leaders, staff members, and suppliers world wide via the computer network 15.

The customized Web pages are created through an interactive process that allows a journey's end user (e.g. traveler) or group leader and a travel agent or salesperson (“user”) to jointly decide upon the details of the journey. Additionally, these Web pages may be modified and updated as travelers and group leaders require. This interactive process creates the personalized Web pages by populating the templates stored in the database 27 with travel information related to the travel information requirements provided by the end user. Populating the template is generally referred to as a back end process for populating the “Back End” Web pages. These Back End Web pages or templates are shown in FIGS. 4-33.

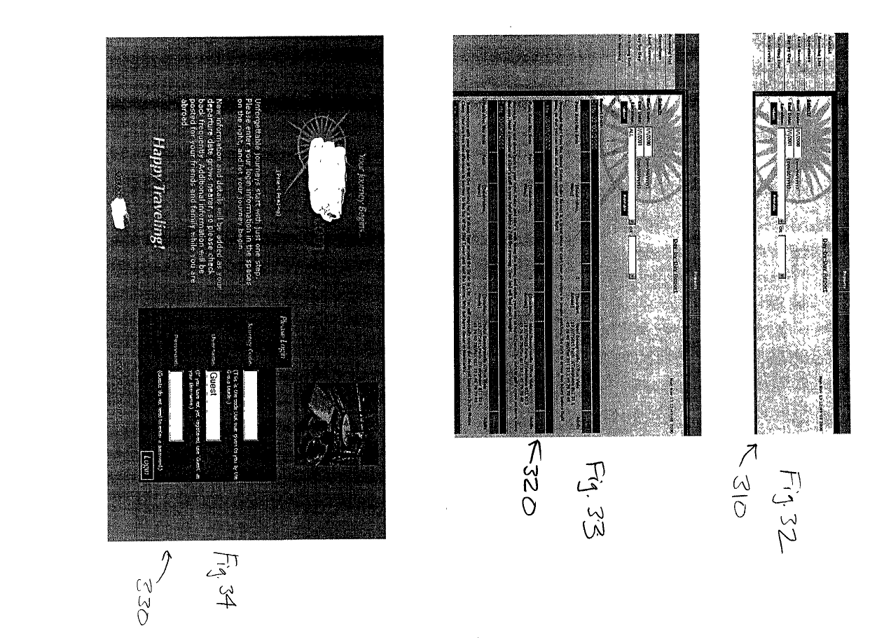

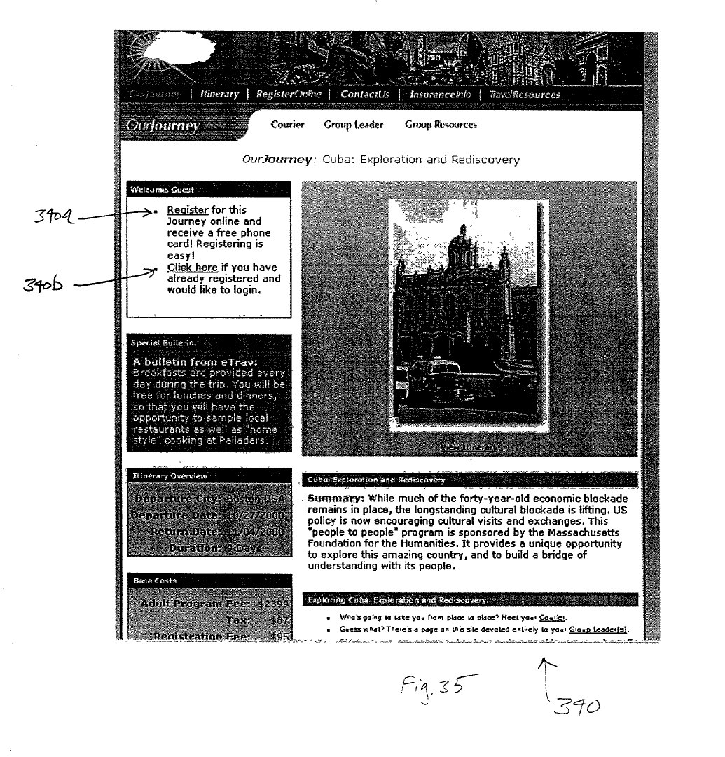

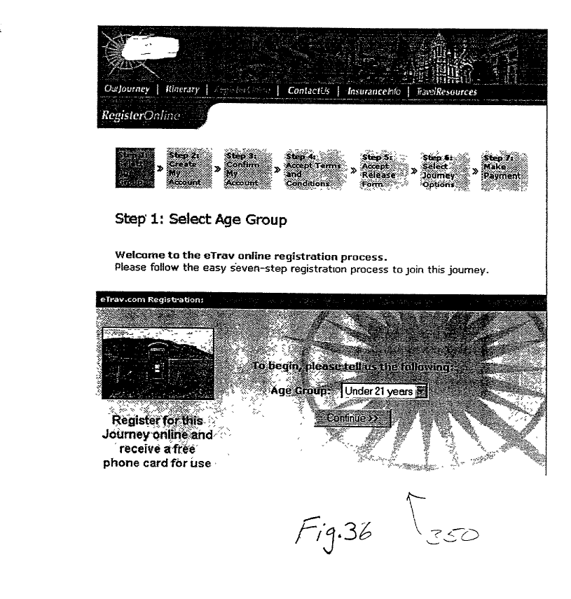

After the templates are populated with the end user's or traveler's personalized travel information requirements, end users or travelers can access and interact (e.g. register for travel) with the personalized Web pages. Interaction with the personalized or customized Web pages is generally referred to as a front end process executed on “Front End” Web pages. These Front End Web pages or customized Web pages are shown in FIGS. 34-54.

In this embodiment, functional aspects of the Journey Maker software running on the server 25 includes enabling a user to create a journey, modify a journey, create a new itinerary, modify an itinerary, maintain core days, create/modify service, administrative functions/security, reports and view a customized journey Web page.

As a security precaution, the user can first login to a first Web site, such as www.journeymaker.com, by entering his or her unique username and password in the dialog box 50 shown in FIG. 2. Additional security measures can been implemented for users accessing the server 25 remotely.

FIG. 3 shows the program's main page 60 for commencing the Back End process. From the main page 60, users can select from the options either by clicking on the buttons at the top of the main page 60, or by clicking the hypertext links.

Journeys are created, modified, and viewed by selecting the “Journey Maker” button 60a (or hypertext link.) of the Journey Maker's main page 60, as shown in FIG. 3. Selecting the Journey Maker button 60a opens the Journey Maker main page 70, as shown in FIG. 4. From the Journey Maker main page 70 of FIG. 3, the user can search for a journey by typing in the name of an existing journey in the appropriate field. The user can also select from a group of journeys by criteria, such as journey location, departure dates, price ranges, or group types. Alternatively, the user can create a new journey by clicking the “Create a New Journey” button 70a.

The process of creating a new journey allows a user or travel agent responsible for the creation and general maintenance of the Journey Maker software to create the journey from a uniform template. The user then adds the required journey data into the various data fields shown in FIG. 4.

The standard template for a Journey's Details input page 80 is shown in FIG. 5. The data fields, as shown in FIG. 5, are required fields, and users may not proceed to the next stage without populating these required data fields. The user can create a unique journey name and a unique journey code login (because the journey login code is the unique key by which the database identifies the journey).

The Journey Status field 80a, as shown in FIG. 5, allows the user to set levels of access by the travelers and group leaders (end users) to the journey as it appears on the “Front End” customized Web page (which will be described in further detail below with reference to FIGS. 35-55). Some examples of possible options for the Journey Status field 80a are as follows: “Open” which is the default and restricts anyone from viewing the journey from the “Front End”; “Published” allows only the group leader's username and password to view the journey from the Front End (i.e. allows end user's with higher level of access to view Front End); “Locked” allows users to view the journey through the Front End logged in as a guest; “Confirmed” locks the journey so that no further changes can be made and “Closed” designates the journey as already having taken place.

After the user has filled in all required information on the Web page shown in FIG. 5, he or she may continue to the next screen by selecting the “Next” button 80c from FIG. 5b.

The Journey Travelers page 90 is a second detail input page, which is shown FIG. 6. In FIG. 6, the user specifies the type of group undertaking the journey, as well as projected and actual numbers of group leaders, assistant group leaders, and travelers. As new travelers sign up for the trip, some fields can be automatically populated. Other fields are manually updated by the user.

FIG. 7 shows the Journey Request page 100, which is a third detail input page. In FIG. 7, the user manually specifies any special requests, such as transportation preferences, hotel and flight information and requested tour guides, or “couriers.” The hotel and flight information is entered in the appropriate fields shown in FIG. 7, which hotel and flight information is displayed on the “Front End” Web pages (FIGS. 34-54).

FIG. 8 shows the Systems Calculations and Stipulations page 110, which is the final detail input page. FIG. 8 displays calculations and stipulations regarding pricing, tax, and other fees. Once the user has completed entering the journey's data, he or she clicks the “Finish” button 100a, and the new journey will be created. The budgeted land and airfare costs are automatically calculated from services added to days of the itinerary (this procedure will be described below), and they are automatically populated in the corresponding fields.

The process of modifying a journey allows the server 25 to modify previously created journeys.

Referring again to FIG. 4, from the Journey Maker main page 70, the user can search by entering the name of the journey he or she wishes to modify (or search by location, departure dates, group type, or price range).

Thereafter, the selected journey and associated fully populated Journey Details page 120 will appear as shown in FIG. 9. The Journey Details page 120 displays the journey name and various view options for the journey.

FIG. 10 shows another Journey Detail page 130. In FIG. 10, the user can click on the “itinerary” folder 130a to open the window 130b represented on Journey Detail page 130. To create a new itinerary, the user can click on the “Create a new Itinerary” button 130c of the page shown in FIG. 10, which opens the “You are creating a new Itinerary” page 140, as shown in FIG. 11.

In FIG. 11, the user specifies the name of the new itinerary, creates a brief description of the itinerary, specifies a departure city, locations for the journey, price for this itinerary, and can insert images to be displayed for this itinerary on the “Front End” customized Web pages.

The user can either save the itinerary details and proceed to add individual days to the itinerary, or he or she can save the itinerary “as is” and assign the itinerary to this journey by selecting the appropriate button shown in FIG. 11b.

Referring again to FIG. 10, rather than creating a new itinerary, the user may choose to assign a pre-existing itinerary from the database 27. The user can either type in the name of an itinerary, or search for available itineraries by length of trip, price range, location, or combination of locations.

FIG. 12 shows a Journey's main menu 150. If an itinerary has already been created, the user can view, edit, or create an itinerary for the journey by clicking on the “Itinerary” folder 150g shown in FIG. 12. The user can then click on the individual days shown in FIG. 12.

FIG. 13 shows an “Edit an Itinerary” page 160. In FIG. 13, the user inputs the name of a new itinerary, the description of the itinerary, city of departure, as well as journey locations (or the user may select a pre-existing itinerary from a list). Additionally and as shown in FIG. 14, the user can select images (usually images of the location to be visited) to be displayed on the customer's customized itinerary page.

In FIG. 15, which shows the “Itinerary Day” list page 170, the user is able to view or edit the individual days listed in the itinerary. The days shown in FIG. 15 can be rearranged using the up/down arrows. The user can edit any one of the Itinerary days by clicking on a hypertext link associated with each Itinerary day. FIG. 16 shows a screen illustrating a user's selection of Saturday, which was selected from the Itinerary days of FIG. 15, for editing. Additionally and as shown in FIG. 16b, the user can elect to add services to the individual days by clicking the “to save day details and proceed to adding Services” button 170a.

FIG. 17 shows a Web page 180 for creating a new service. In FIG. 17, the user can specify the category, subcategory, class, location, season, and cost for the particular service. Additionally, he or she can add a description of the service, and associate an image to be displayed with the service on the “Front End” customized Web pages (FIGS. 35-55).

FIG. 18 shows a Web page 190 for searching for services. In FIG. 18, the user can either search for a service by name, category, subcategory, class, or location, or create a new service.

By viewing the drop-down menus, the user can select from available services. As shown in FIG. 19, when the user selects a category drop down menu 190a, from the Web page 190, the drop-down menus for corresponding subcategories, classes, and locations also change, as shown in the Web page 195 of FIG. 19.

Referring again to FIG. 12, which show the Journey's main menu 150, the user can also edit the journey's Group Leader by selecting the “Group Leader” folder 150a. Selecting the Group Leader folder 150a opens the Web page 200, as shown in FIG. 20, for editing a group leader. The user can enter a name and biographical information for the group leader, as well as the group leader's picture (if supplied by group leader), as shown in Web page 205 of FIG. 21. Additionally, the user enters a username and password for the group leader to access his personalized Web page.

From the Journey's main menu 150, as shown in FIG. 12, the user may also edit and view information on the Assistant Group Leader and Courier by selecting the “Assist. Group Leader” folder 150b or the “Courier” folder 150c. The process for editing the Assistant Group Leader and/or Courier is similar to that of the Group Leader described above.

Again, from the Journey's main menu 150, as shown in FIG. 12, the user may also view Enrollment information by selecting the “Enrollment” folder 150d, which open the Enrollment Information page 210 is shown in FIG. 22. In FIG. 22, the user can view early enrollment dates and assign early enrollment credits to travelers. Late charges can also be automatically populated in the appropriate fields if the traveler enrolls after the enrollment due date.

Again from the Journey's main menu 150, as shown in FIG. 12, the user can also specify either open enrollment for the journey by selecting the “Journey Constraints” folder 150e, which opens the Enrollment Constraints page 220, as shown in FIG. 23. In FIG. 23, the user can specify certain constraints such as age or requirements for teacher/parent consent.

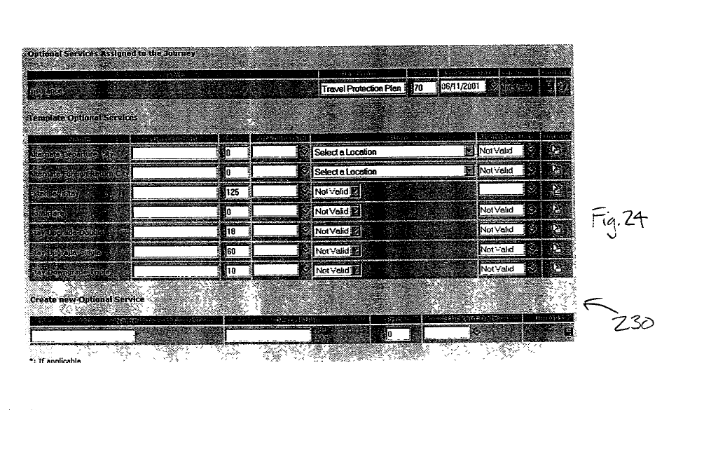

Finally, from the Journey's main menu 150, as shown in FIG. 12, the user can edit and view optional services for the journey (such as alternate departure cities, extended stays, upgrades in travel, and other optional services), by selecting the “Optional Services” folder 150f opens the Web page 230, as shown in FIG. 24. In FIG. 24, the user can manually enter optional information related to the journey.

FIGS. 25-31 show example Web pages or screens for managing information related to operations, administrative, and reporting functions. In particular, the Content Manager page 240 (FIG. 25) is a data entry tool used to add, delete, and modify couriers, travelers, group leaders, vendors, itineraries, services, and locations that make up the journey. In FIG. 25, the user can edit itineraries, core days (daily schedules within the journey itineraries), services (such as hotel or travel accommodations), assigned group leaders, couriers, vendors, locations, and registered travelers.

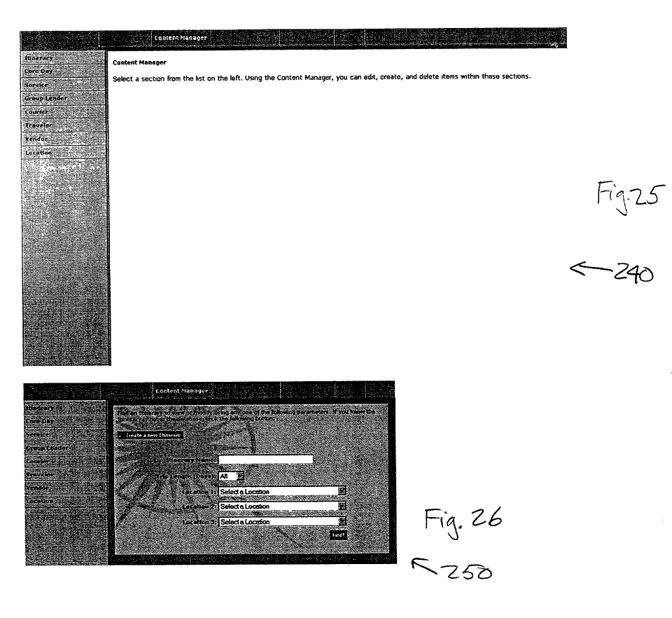

The process for viewing, editing, and creating itineraries through the Content Manager page 240 is the same as the itinerary functions under the Journey Maker main page 150 (FIG. 12). In the Web page 250 of FIG. 26 however, the user creates itineraries to the “core group” of itineraries. Hence, itineraries created here need not be associated with a specific journey. They are available for all journeys.

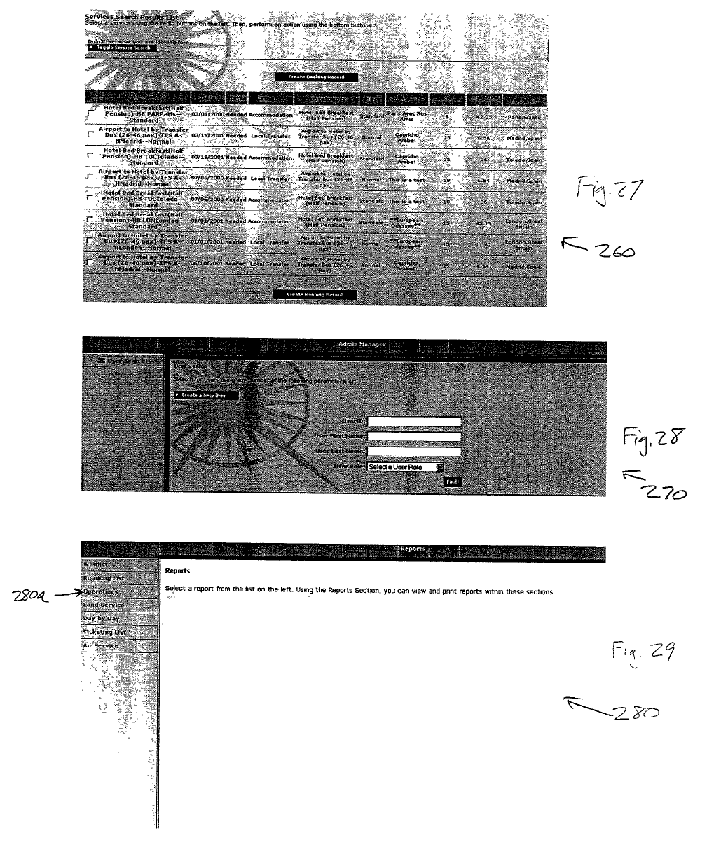

Through the “Services Search Results List” page 260, as shown in FIG. 27, the user can search through the list of journeys for specific services or view all services for a specific journey or view all services being used by journeys that fall under certain categories, subcategories, classes, and locations. This page 260 gives a list of available service providers, such as hotel, airline or touring services.

The process for viewing, modifying, and adding items under the remaining options within Content Manager page 240 (FIG. 25) is similar to that as described above. The key difference between the Content Manager page 240 options and options within the Journey Maker main page 150 (FIG. 12) is that the changes made under the Content Manager page 240 are posted to the master database defined in the database 27. The master database stores archival travel information, which can be accessed by users or travel agents when creating new journeys for future end users or travelers. Additionally, certain functions such as adding locations are only available through Content Manager page 240.

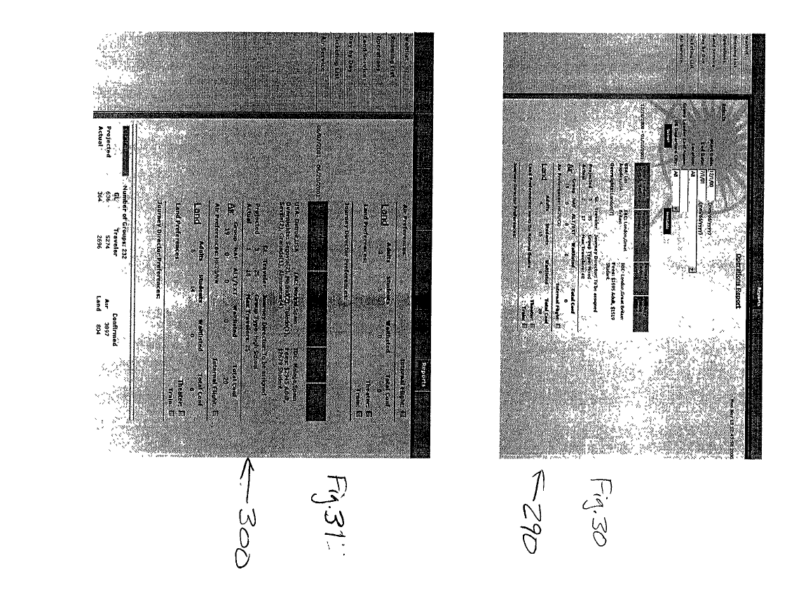

The Administrative Manager page 270 is shown in FIG. 28. The user can search for existing users by user ID or first or last name, or create a new user account. Administrators can also control levels of user access.

FIG. 29 shows the Reports page 280. The search forms for each report allow the user to search by any criteria vital to the service. For example, the Operations report folder 280a allows users to view information on services, traveler statistics, projected travelers, actual travelers, fees, and other vital information. The user can search the database for journeys by start/end date, location, group leader name, or departure city. Examples of the Operations report are shown in FIGS. 30 and 31 respectively as Web pages 290 and 300. The bottom of the Operations report 290 displays a summary of totals.

Additionally, the user can search the database 27 for individual days within the existing itineraries. The Day-by-Day reports can be sorted by start/end date, or by location using the Web page 310 shown in FIG. 32. Further, the Day-by-Day results can be displayed in the Web page 320, as shown in FIG. 33.

Other available functions through the Operations folder 280a can include reports displaying all travelers waitlisted, categorized land and air service, and ticketing information for registered travelers.

After the user or travel agent has created and/or modified the journey and its components, the journey can be made available to travelers, group leaders or the general public through a separate Web site, such as: www.etravjourneys.com. The journeys are represented as one or more “Front End” customized Web pages.

In FIG. 34, travelers and group leaders, which are hereinafter collectively referred to as “end users”, are presented with a login page 330. The login page enables end users to login to the server 25 for accessing the “Front End” customized travel Web pages shown throughout FIGS. 35-54. As a security precaution, the end user should login to the site using the unique username and password issued to him by the group leader. Additionally, to view a journey, the end user should enter the unique journey code, which was previously assigned to the journey at its creation. After logging into the server 25, the end user can view their “Front End” customized travel Web page 340, as shown in FIG. 35. In the journey's “Front End” customized travel Web page of FIG. 35, the end user can view bulletins about the journey, an itinerary overview specifying dates and departure cities, a summary of the journey, and costs associated with the journey. Additionally, the end user may register online for the journey by clicking on the “Register” hyperlink 340a. Clicking the register hyperlink 340a opens the Web page 350, as shown in FIG. 36. Alternatively, if the user has signed on to the journey as a guest, but is nevertheless registered for the journey, he or she may login by clicking the “Click here” hyperlink 340b of FIG. 35.

In FIGS. 36-38, which corresponds to Web pages 350, 360 and 370, an end user can register for a particular journey by filling out the various fields. The end user can select the traveler's age group and then create the account. Creating an account requires the end user to create a unique username and password to access the online journey. The end user can provide personal information such as name, address, billing address, credit card information, name of spouse (if traveling with spouse), and emergency contact information. In the event that the end user should forget his or her password, the system requires him or her to specify a secret question and answer to provide the user access to his or her password.

In the “Confirm My Account” page 380 of FIG. 39, the end user can confirm the account The page, as shown in FIG. 39, displays a summary of previously entered information for the end user to view before proceeding further.

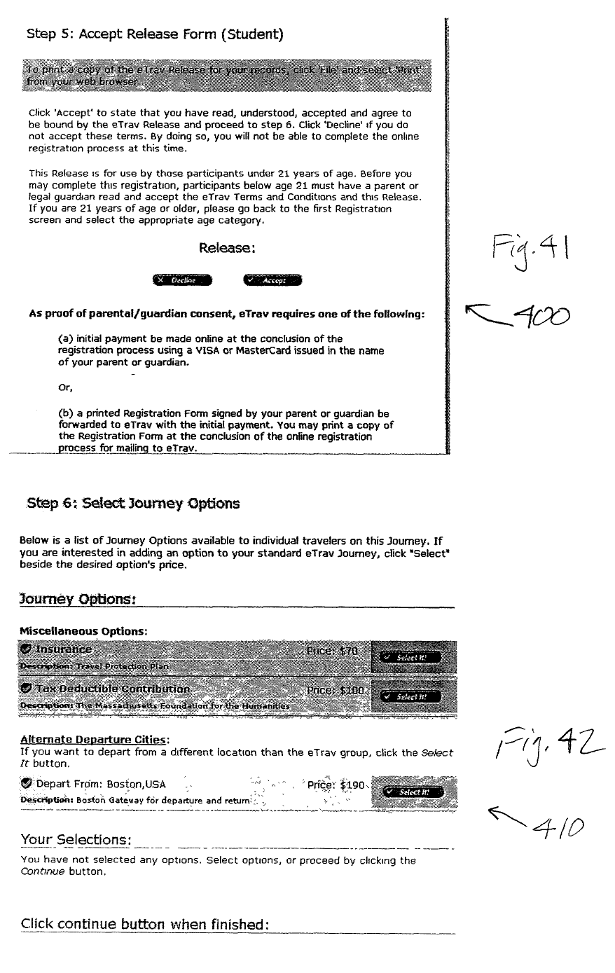

In the “Accept Terms and Conditions” page 390 of FIG. 40, the end user can accept or decline the terms and conditions of the selected journey and associated agreement. As the end user scrolls down the page, he or she can read the terms and conditions of the agreement. The hypertext links scroll the user directly to the corresponding terms of the agreement (or the user can scroll down manually).

In the “Accept Release Form” page 400 of FIG. 41 the end user can accept or decline the release form.

In the “Select Journey Options” page 410 of FIG. 42, the end user can select journey options. The page 410, as shown in FIG. 42, allows the user to buy insurance, to make a tax deductible contribution to a charity, or to select an alternate departure city.

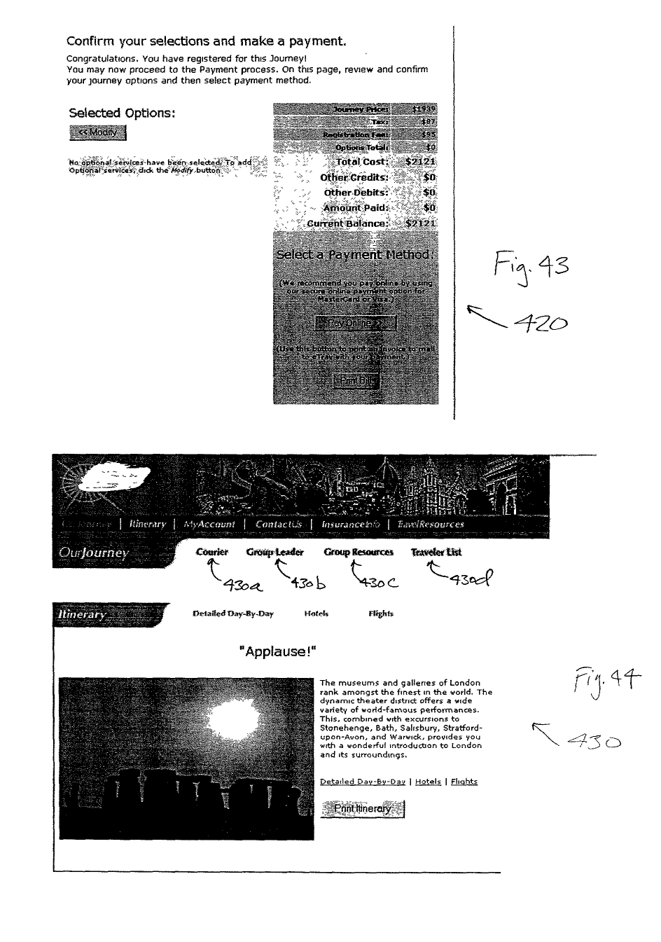

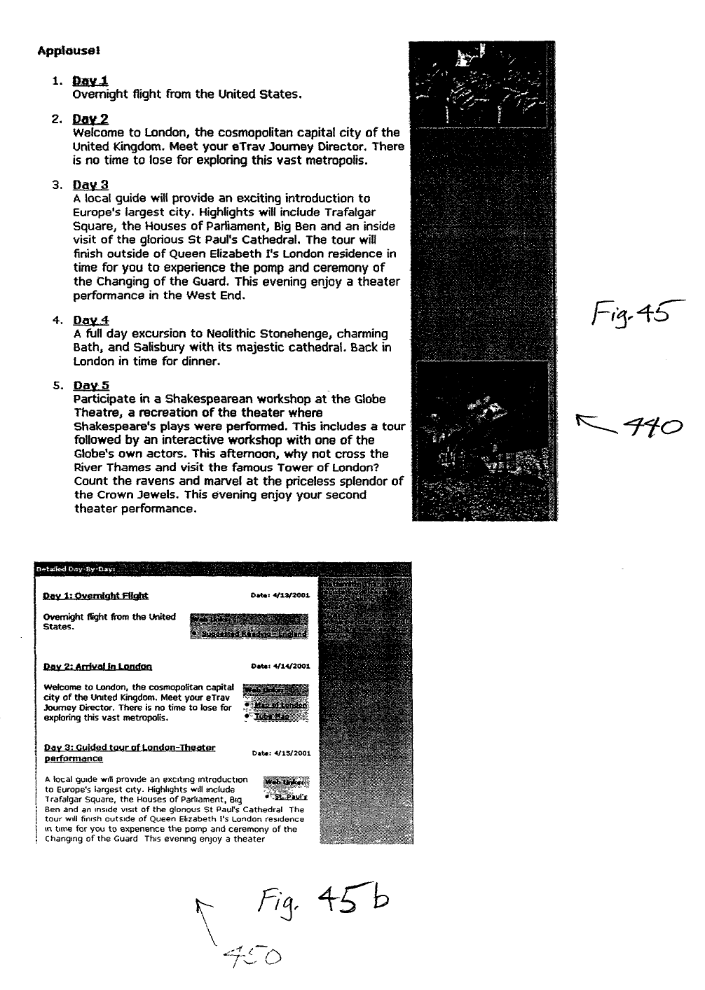

Finally, the “Confirm your selection and make payment” page 420 of FIG. 43 shows the last step for registration, which is to make payment. The end user may either elect to pay online, or to print a bill for payment by mail.

FIG. 44 show an “Our Journey” main page 430, which provides the end user with a variety of options. Among these options are the ability to view the journey itinerary, insurance information for the journey, information on the courier, the group leader, a list of registered travelers or contact a user and/or staff member.

The itinerary of the selected journey is shown in the Web page 440 of FIG. 45. FIG. 45 displays a picture selected as noted above in the journey maker “Back End.” (FIGS. 2-33). As the end user scrolls down, he or she can view a summary of the individual itinerary days, or view a more detailed view by clicking on the hyperlinks for each day.

The end user can also view the journey by detailed day-by-day description, hotel, or flight information as shown in the Web page 450 of FIG. 45b. The system can also displays useful Web links such as suggested readings for the journey, maps of the areas, and pages containing historical information about the journey destinations. The end user can further view information related to assigned hotels in the Web page 460 of FIG. 45c and travel arrangements in the Web page 470 of FIG. 45d.

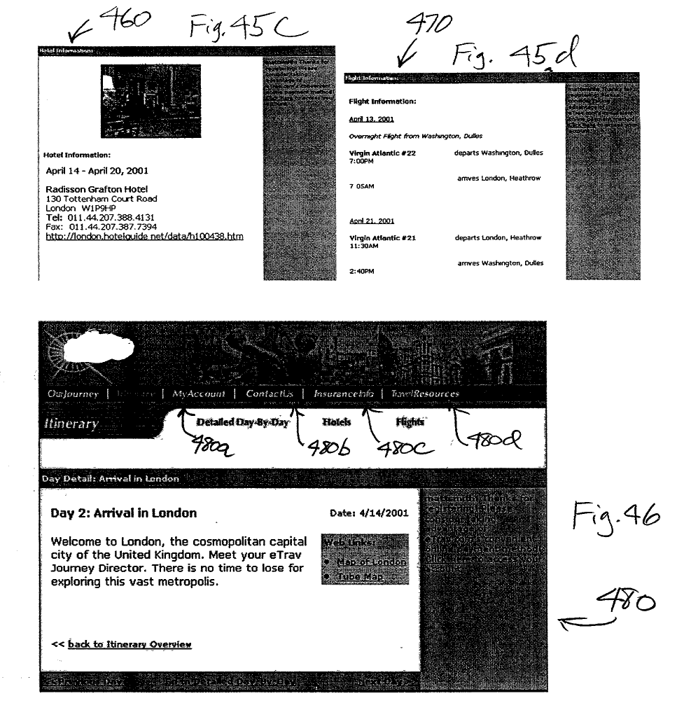

FIG. 46 shows a Web page 480 of an individual day selected from the Web page 440 of FIG. 45. The Web page of FIG. 46 also displays a link to a map of the geographical area covered by the day, and various other links such as information on local public transportation.

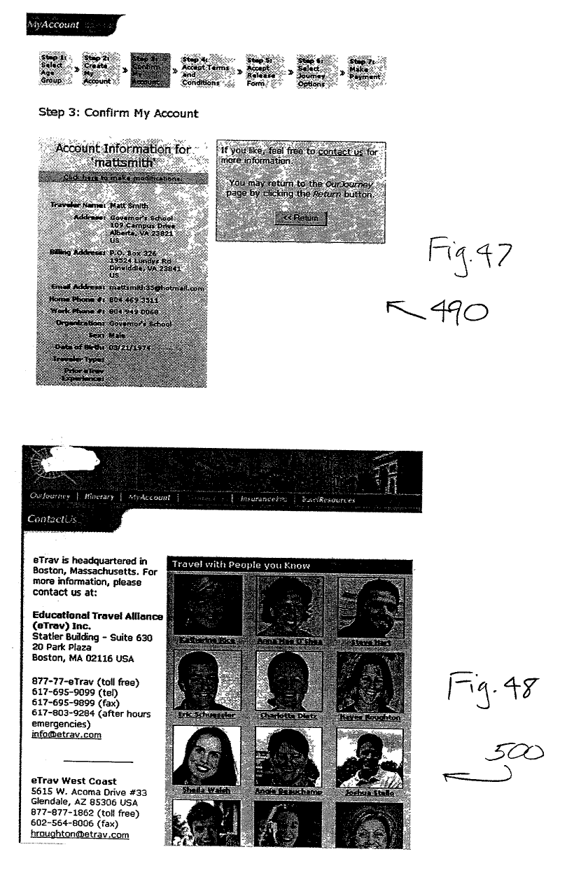

By clicking the “MyAccount” option 480a at the top of the Web page of FIG. 46 (as well as from other various screens), the end user will be presented with the “My Account” page 490 as shown in FIG. 47. In FIG. 47, the end user can view and edit his account information.

By clicking the “ContactUs” option 480b at the top of the Web page 480 of FIG. 46 (as well as from other various screens), the end user will be presented with the “ContactUs” page 500 as shown in FIG. 48. In FIG. 48, the end user can view information associated with user and/or staff members and the user can email staff members by clicking on their pictures.

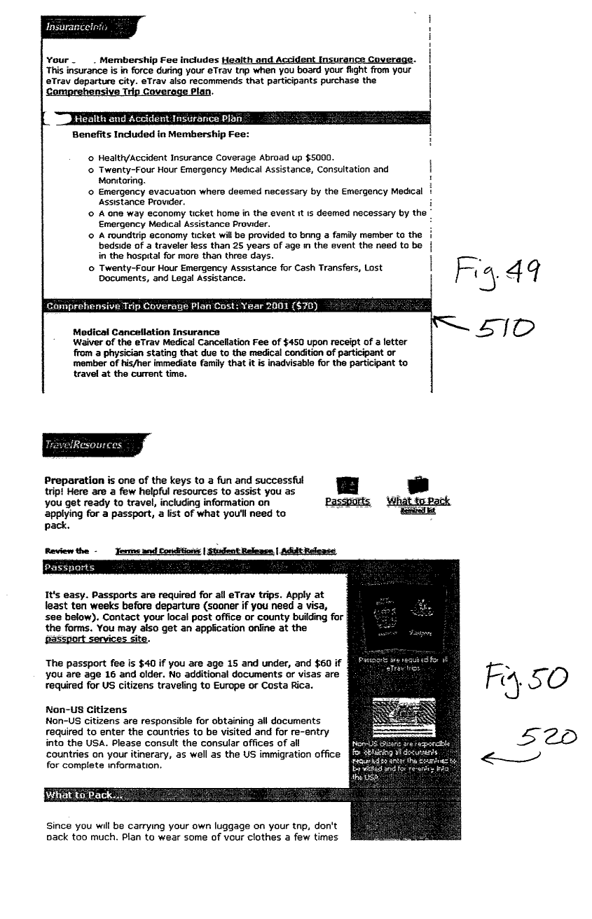

By clicking the “InsuranceInfo” option 480c at the top of the Web page of FIG. 46 (as well as from other various screens), the end user is presented with the “InsuranceInfo” page 510, as shown in FIG. 49. In FIG. 49, the end user can elect to obtain various forms of insurance.

By clicking the “TravelResources” option 480d at the top of the Web page of FIG. 46 (as well as from other various screens), the end user can be presented with the “Travel Resources” page 520, as shown in FIG. 50. In FIG. 50, the end user can view a wealth of information for preparing for a journey. The information for preparing for a journey can include information such as what to pack and how to obtain a passport.

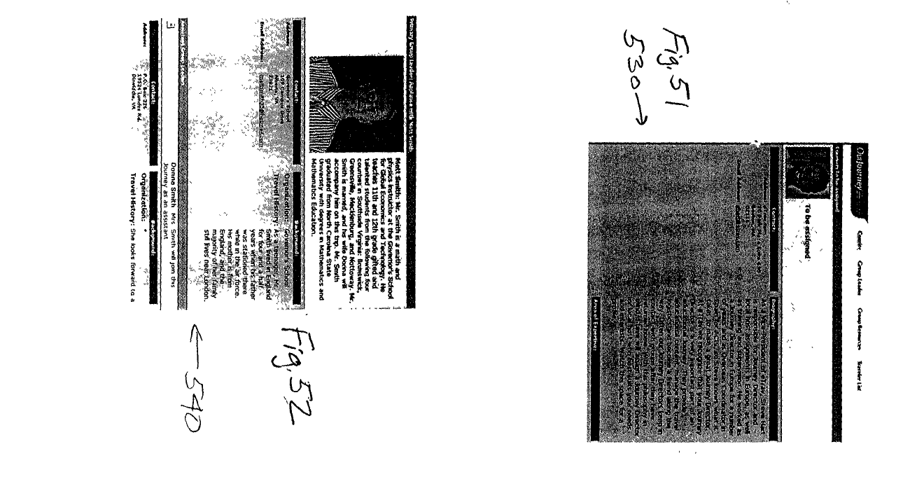

From the “Our Journey” main Web page 430 of FIG. 44, the end user can also select “Courier” 430a, “Group Leader” 430b, “Group Resources” 430c and “Traveler List” 430d options. Selecting the Courier option 430a eenables the end user to view the Web page 530 of FIG. 51, which includes information related to the courier associated with the journey. Selecting the Group Leader option 430b enables the end user to view the Web page 540 of FIG. 52, which includes information related to the group leader of the journey. Selecting the Group Resources option 430c enables the end user to view information related to the group resources, such as homework assignments and assigned readings by the group leader. Selecting the Traveler List option 430d enables the end user to view a Web page 560 of FIG. 54, which includes information related to the registered travelers for the journey, as well as travelers that are wait listed.

The above described method and system for providing a user with an internet-based customized travel program Web page has many advantages over the prior art such as enabling a user to customize their travel itinerary by being able to select from one a plurality of excursion choices provided in the Web page. Additionally, the user can select from one of a plurality of airlines, hotels, and/or travel insurance plans, which are also provided in the Web page. Therefore, the user can easily arrange relatively complex travel plans based on user defined travel requirements.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A system for creating at least one customized travel Web page over a computer network, the system comprising:
a server coupled to the computer network;
a database coupled to the server for storing travel archival information; and
at least one client computer coupled to the server over the computer network,
wherein the server is constructed and arranged to receive travel information requirements from the at least one client computer over the computer network and to process the travel information requirements to generate the at least one customized travel Web page.

2. The system of claim 1, wherein the database further includes:
a plurality of templates,
wherein the server is constructed and arranged to query the travel archival information stored in the database for locating travel match information and for populating the plurality of templates with the travel match information to generate the at least one customized travel Web page.

3. The system of claim 2, further including:
at least one vendor computer coupled to the server over the computer network,
wherein the at least one vendor computer is adapted to receive the travel information requirements from the server and to locate travel match information, the travel match information being communicated to the server, the server populating the plurality of templates with the travel match information to generate the at least one customized travel Web page.

4. A method for creating at least one customized travel Web page over a computer network, the method comprising the steps of:
receiving travel information requirements at a server;
generating the at least one customized travel Web page having information related to the travel information requirements; and
presenting the at least one customized travel Web page to at least one client computer for enabling a user of the at least one client computer to obtain travel related information, services or to consummate travel reservations.

5. The method of claim 4, wherein the step of generating the at least one customized travel Web page further includes the steps of:
comparing the travel information requirements to archived travel information stored in a database to locate travel match information; and
populating a plurality of Web page templates with the travel match information to generate the at least one customized travel Web page.

6. The method of claim 5, further includes the steps of:
communicating the travel information requirements to at least one vendor computer; and
receiving vendor information from the at least one vendor computer, the vendor information being related to the travel information requirements.

7. The method of claim 6, further including the step of:
populating the plurality of Web page templates with the vendor information to generate the at least one customized travel Web page.

8. The method of claim 4, wherein the method further includes the step of:
storing the plurality of customized travel Web pages in the database.

9. The method of claim 4, wherein after the step of presenting at least one customized travel Web page to the at least one client computer, the method further includes the step of:
communicating information from the at least one client computer to the at least one vendor computer to consummate travel reservations.

10. The method of claim 4, wherein after the step of presenting the at least one customized travel Web page to the at least one client computer, the method further includes the step of:
communicating information from the at least one client computer to the server computer to consummate travel reservations.

11. The method of claim 4, wherein after the step of presenting the at least one customized travel Web page to the at least one client computer, the method further includes the step of:
debiting an account of an end user of the at least one client computer a predetermined fee.

12. The method of claim 4, wherein after the step of presenting the at least one customized travel Web page to the at least one client computer, the method further includes the step of:
charging an end user of the at least one client computer a predetermined fee.
